(19) United States
(12) Patent Application Publication
(10) Pub. No.: US 2004/0178032 A1
(43) Pub. Date: Sep. 16, 2004

(54) Hydropneumatic suspension

(76) Inventor: Michael Kuhn, Wotenitz (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/702,724

(22) Filed: Nov. 7, 2003

(30) Foreign Application Priority Data
Nov. 13, 2002 (DE) 102 52 729.6

(51) Int. Cl. F16F 9/24

(52) U.S. Cl. 188/297

(57) ABSTRACT

A hydropneumatic suspension has at least one suspension cylinder, at least one suspension accumulator, especially a hydraulic accumulator, and a controllable valve 20, especially a proportional valve, for opening and closing a fluid-carrying connection between the suspension cylinder and the suspension accumulator. The controllable, especially pilot-actuated, valve 20 can be moved into a closed position by a hydraulic trigger. Electrical actuation is completely avoided. Reliable hydraulic actuation of the pilot-actuated valve 20 is effected for connecting and disconnecting the suspension accumulator of the hydropneumatic suspension.

### FIELD OF THE INVENTION

The present invention relates to a hydropneumatic suspension with at least one suspension cylinder and one suspension accumulator, especially a hydraulic accumulator. A controllable valve, especially a proportional valve clears or blocks a fluid-carrying connection between the suspension cylinder and suspension accumulator.

### BACKGROUND OF THE INVENTION

The hydropneumatic suspensions of the present invention are intended to be used, for example, as rear axle suspensions in tractors and other machinery. If a fluid-carrying connection between the suspension accumulator and the suspension cylinder, especially in the form of a conventional hydraulic accumulator or operating cylinder connected to the respective wheel set of the tractor, is established by way of the controllable valve, the pertinent wheel axle is sprung accordingly for the respective application. If, at this point the machine, especially in the form of a tractor, is intended to perform work, for example, plow a field with a plow, the suspension can be blocked, i.e., the connection between the suspension cylinder and the suspension accumulator is interrupted by the controllable valve. This operation has the advantage that the “working height” of the plow or another operating implement does not change unintentionally since this change could adversely affect the respective application under consideration.

The disclosed technical approaches for the shutdown of the hydropneumatic suspension use exclusively electrical actuation of the controllable stop valve. Since this controllable valve is rather large relative to the high flow amounts to be managed, in turn large actuation forces for switching the valve are necessary. The large required actuating forces, in turn, lead to actuating magnets with correspondingly large dimensions for triggering the valve, which actuating magnets also have a correspondingly high electrical current consumption. Furthermore, when the hydropneumatic suspension is shut down, in which the controllable valve assumes a blocking position, the drive concept in question is rigidly laid out. The effects on the operating implement, for example, due to the unevenness of the ground over which the tractor or machine is driving, result in the corresponding disruptive effects being relayed to an operating implement, such as a plow. Clearly, these disruptive effects can adversely affect the actual plowing process. The vehicle certainly is to be designed to be stiffer in its driving characteristic than the control of the plow, so that a working process, such as plowing, is reasonably possible at all.

### SUMMARY OF THE INVENTION

One object of the present invention is to provide a hydraulic suspension for commercially available tractors and machinery that avoids the problems of conventional suspensions.

Another object of the present invention is to provide a hydraulic suspension, with a valve control which has a small structure, which is favorable in terms of energy, which permits, even under different loads on the operating implement of the machine, load equalization in operation to avoid problems during operation.

The foregoing objects are basically obtained by a hydropneumatic suspension, comprising at least one suspension cylinder, at least one suspension accumulator, and a controllable valve connecting the cylinder and the accumulator. The controllable valve is movable between an open position providing fluid communication therethrough and a closed position blocking fluid communication therethrough, and is movable to the closed position by a hydraulically operated control.

By the controllable valve being moved into the closed position by a hydraulically operated control, the previously and exclusively electrical actuation approaches are completely avoided. An exclusive hydraulic actuation of the controllable, especially pilot-actuated valve for connecting and disconnecting the suspension accumulator of the hydropneumatic suspension takes place. The hydraulic control concept allows application of large actuation forces which are necessary to be able to reliably trigger the controllable valve in the manner of a pilot-actuated valve with its high flow rates. Based on the exclusively hydraulic control concept, it is possible to completely omit the actuating magnets which are designed to be correspondingly large and costly. The approach of the present invention permits the apparatus to be made smaller overall and to become more economical. Since the hydropneumatic suspension uses a hydraulic medium, another type of energy (electric current) need not additionally be used to operate the suspension efficiently. This arrangement in turn reduces the production and maintenance costs.

Preferably, the hydraulic control taps the fluid pressure between the suspension accumulator and the suspension cylinder, and relays it by a switching valve to the actuation side of the pilot-actuated valve.

Preferably, the tapping of the fluid pressure for the actuation of this pilot-actuated valve between the pilot-actuated valve and the suspension accumulator takes place so that a relatively high actuation pressure is available by the suspension accumulator.

In one preferred embodiment of the hydropneumatic suspension of the present invention, a choke is between the switching valve and the actuation side of the pilot-actuated valve. In the secondary branch parallel to this choke, a return valve opens spring-loaded in the direction of the actuation side of the pilot-actuated valve. The pilot-actuated valve can open only slowly, and thus, pressure differences between the respective suspension cylinder and suspension accumulator are prevented so that undefined movements of the suspension cylinder cannot occur in the described unblocking of the suspension.

In another especially preferred embodiment of the hydropneumatic suspension of the present invention, in a further secondary branch to the pilot-actuated valve between the suspension accumulator and the suspension cylinder, another choke or an orifice is connected. As a result of this choke or orifice, with the hydropneumatic suspension blocked, slow load equalization between the suspension accumulator and the suspension cylinder can take place. Thus, in any case, it is ensured that the motor vehicle with its suspension is designed to be stiffer in control than the towed plow or other operating implement.

Should it happen that the time of slow load equalization is not sufficient for complete load equalization and if the suspension is to be unblocked for its actuation, the pertinent load equalization is attained by the choked opening of the pilot-actuated valve. If the suspension is to be blocked in working operation, according to the circuit of the present invention, it is possible by way of a pilot valve, which has a small structure, to block the pilot-actuated valve by the hydraulic medium due to the stored pressure in the suspension accumulator.

Alternatively to the above described approach, the choke between the switching valve and the actuation side of the controllable valve can be omitted together with the associated return valve in the secondary branch. Instead, between the input of the switching valve and the tank, a flow control valve can be connected upstream of the branch of a connecting line extending to the reset side of the valve. With such configuration, the correspondingly same effects and advantages can be achieved as with the hydraulic circuit described above. Furthermore, instead of the switching valve acting on the actuation side of the pilot-actuated valve, a proportional valve with which especially gentle connection of the pressure accumulator is possible.

Other objects, advantages and salient features of the present invention will become apparent from the following detailed description, which, taken in conjunction with the annexed drawings, discloses preferred embodiments of the present invention.

### BRIEF DESCRIPTION OF THE DRAWINGS

Referring to the drawings which form a part of this disclosure:

FIG. 1 is a schematic circuit diagram of a hydropneumatic suspension according to the present invention.

### DETAILED DESCRIPTION OF THE INVENTION

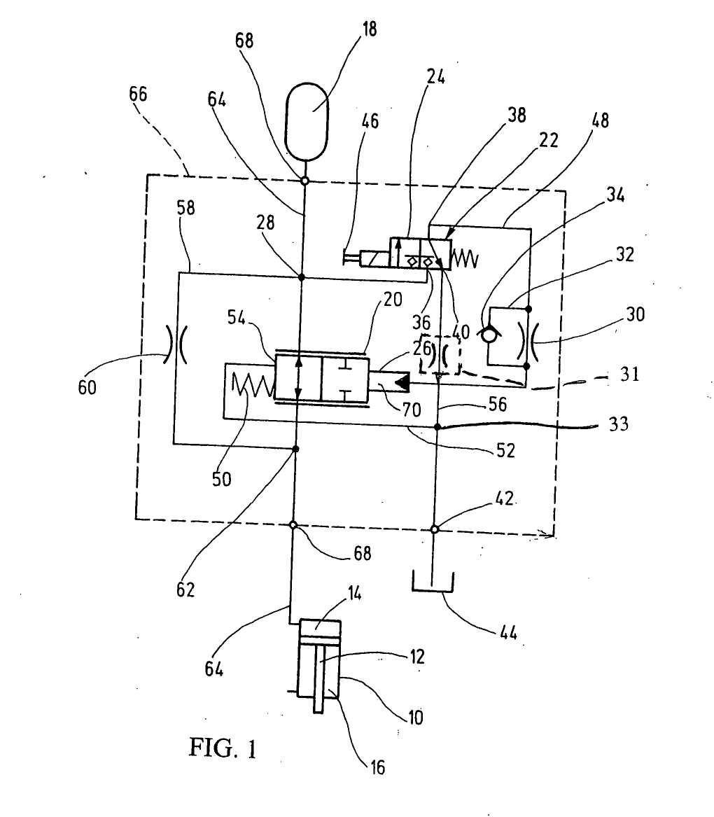

The hydropneumatic suspension, as shown in FIG. 1, has a conventional suspension cylinder 10. The suspension cylinder 10 is provided with a piston rod 12. The free end of the piston rod includes the wheel axis of a respective wheel set (not shown). When the piston rod unit 12 moves back and forth within the suspension cylinder 10, a hydraulic medium is pushed into and out of, in the conventional manner, the two working spaces 14 and 16, so that further pertinent details need not be described.

The suspension cylinder 10, as will be described, can be dynamically connected to a suspension accumulator 18 in the form of a conventional operating or hydraulic accumulator. For example, accumulator 18 can be in the form of a membrane or bladder accumulator. A separating means (not shown) in the form of a separating membrane or bladder separates the hydraulic medium for the suspension from the gas supply in the accumulator, with a pressure cushion determining the spring stiffness for the respective suspension cylinder 10. The pertinent arrangement is fundamentally conventional for hydropneumatic suspensions so that further details in this connection need not be described.

As shown, a suspension cylinder 10 can be assigned to the suspension accumulator 18. However, embodiments are also conceivable in which multiple suspension cylinders 10 and suspension accumulators 18 are arranged, with each suspension accumulator 18 triggering several suspension cylinders 10 for their deflection processes. Between the suspension cylinder 10 and the suspension accumulator 18, a pilot-actuated valve 20 is connected and is shown in its neutral position, i.e., in the switched-through, open clearing position in which the working space 14 is dynamically connected to the fluid side of the suspension accumulator 18 to carry fluid. In this way, the hydropneumatic suspension for the wheel set or wheel axle is formed.

The pilot-actuated valve 20 is preferably in the form of a proportional valve. It can be moved into the closed position by a hydraulic trigger means, designated as a whole as 22, in which position the fluid-carrying connection of the pilot-actuated valve 20 is interrupted between the suspension cylinder 10 and the suspension accumulator 18. The hydraulic trigger means 22 taps the fluid pressure between the suspension accumulator 18 and the respective suspension cylinder 10 and routes the tapped fluid pressure by a switching valve 24 to the actuating side 26 of the pilot-actuated valve 20. In particular, the tapping of the fluid pressure for actuating the pilot-actuated valve 20 is between valve 20 and the suspension accumulator 18 at tapping site or point 28. Between the switching valve 24, in the form of a 3/2 way-seat valve of conventional design, and the actuating side 26 of the pilot-actuated valve 20, a choke 30 is connected. In the secondary branch 32 to this choke 30, a conventional non-return valve 34 is connected and opens spring-loaded in the direction of the actuating side 26 of the pilot-actuated valve 20.

As shown in FIG. 1, in the switched-through clearance position of the pilot-actuated valve 20, the switching valve 24 is in the illustrated operating position in which the first input 36 of the switching valve 24 is connected to the tapping site 28 to carry fluid and is blocked from the output 38 of the switching valve 24. The other or second input 40 of the switching valve 24 is connected to the tank connection 42, leading to the tank 44, to carry fluid. When the switching valve 24 is actuated, for example, by a conventional hand lever 46 in the driver's compartment of the machine, the switching valve 24 is switched through and first input 36 is connected to the output 38 to carry fluid. Moreover, the tank connection 42 is blocked. In the suspension-loaded reset position as shown, when the hand lever 46 has not been actuated, conversely the other or second input 40 is connected to the output 38 to carry fluid, and thus, through tank connection 42 a fluid-carrying connection is provided between the tank 44 and the connecting line 48 to which the choke 30 is connected to carry fluid.

Downstream of the choke 30, the connecting line 48 leads in a fluid carrying connection to the actuating side 26 of the pilot actuated valve 20. As long as the hydraulic trigger means 22 is not actuated, as shown in the figure, the pilot-actuated valve 20 is held in its illustrated open position by the mechanical reset spring 50. Furthermore, there is a fluid-carrying connection through the connecting line 52 between the reset side 54 of the pilot-actuated valve 20, located on the opposite side of the actuating side 26 on the valve 20, and a line 56 to discharge fluid pressure into the tank connection 42. The pertinent line 56 is also connected to the other or second input 40 of the switching valve 24.

Another choke 60 or an orifice (not shown), designed depending on the viscosity of the fluid, is connected in another secondary branch 58. The other secondary branch 58 discharges with its free end into the tapping point 28. The other end of branch 58 opens into the connecting point 62. Besides the tapping point 28, connecting point is part of the connecting line 64 between the suspension cylinder 10 and the suspension accumulator 18.

The above described operating components can be combined into a shutoff block 66 which is shown by the broken line in FIG. 1. The shutoff block can also be used as a retrofit kit for improvement of existing hydropneumatic suspensions. The two connections 68 for the suspension cylinder 10 and for the suspension accumulator 18 and the tank connection 42 of the shutoff block 66 can be standardized so that installation of the shutoff block 66 in existing groups of assemblies is facilitated. The actuating side 26 has preferably one hydraulic pilot part 70, with its pilot piston, preferably together with the parts of the controllable valve 20, made as a slide sealed by sealing means (not shown) both to the actuating side 26 and also to the reset side 54.

For the sake of better understanding the operation of the shutoff block 66 for the hydropneumatic suspension of a machine, especially for the rear axle suspension of a tractor (not shown) is described. The shutoff block 66 uses the pilot-actuated 2/2-way valve as the controllable valve 20 for blocking the hydropneumatic suspension comprising the respective suspension cylinder 10 and the respective suspension accumulator 18. As the pilot pressure for triggering the valve 20, the existing pressure in the suspension accumulator 18, in the form of a conventional hydraulic accumulator, is used. The shutoff block 66 is characterized in that slow decay of the pressure differences between the suspension cylinder 10 and the suspension accumulator 18 is possible to avoid undefined movements of the suspension cylinder 10 when the suspension is unblocked by the controllable valve 20, if it is moved in the direction of its opened position illustrated.

In the opened position of the controllable valve 20 illustrated, the suspension cylinder 10 is connected to the suspension accumulator 18 to carry fluid. In this way, the hydropneumatic suspension is engaged. In the blocked position (not shown), the switching valve 24 in the form of a 3/2-way seat valve is actuated by the hand lever 46 or other hand control or a controllable electromagnet. In this way, the suspension accumulator 18 is connected to the pilot part 70 of the controllable valve 20 to carry fluid. As a result of the operating pressure on pilot part 70, this valve 20 is closed. Since the controllable valve 20 a proportional valve, the opening process proceeds continuously. In the closing process of the valve 20, an amount of fluid is displaced into the tank 44 by the connecting line 52 from the reset side 54 in the direction of the tank connection 42. In this way, hindrances during switching of the valve piston for the valve 20 are avoided, and the closing process takes place uncontrolled and brakeless.

In the blocked position (not shown) of the valve 20, the suspension cylinder 10 remains connected to the suspension accumulator 18 to carry fluid through the choke 60, or an orifice (not shown) and which can replace that choke with an assignable cross section as an alternative. As a result, pressure differences between the hydraulic accumulator 18 and the cylinder 10 due to load changes (loading/unloading) in the blocked state and undefined movements of the suspension when the valve 20 is unblocked in the direction of its opening or clearance position are prevented. The branch of the choke 60 is optional, and can also be omitted.

In addition or alternatively, the pilot line in the form of the connecting line 48, connecting the 3/2-way valve 24 to the piston surface of the pilot part 70 of the valve 20, can be provided with a choke 30 and, in its secondary branch 32, with a return valve 34. In this manner, in the direction of the open position, the return valve 34 blocks and through the choke 30 the displaced fluid is reduced by the pilot-actuated valve 20 so that the valve 20 opens slowly and the aforementioned pressure differences are likewise slowly reduced.

If the hydropneumatic suspension of the present invention is used in tractors which move operating implements, plows, or the like, the application causes different loads and slow load equalization to occur between the suspension accumulator 18 and suspension cylinder 10 by way of the choke 60. If this time of slow load equalization is not sufficient for complete load equalization and the suspension is to be unblocked, the load equalization is achieved by choked opening of the pilot-actuated valve 20 by the other choke 30. For blocking the suspension in the hydraulic circuit of the present invention, only a small pilot valve 24 need be actuated. As a result of the prevailing pressure in the suspension accumulator 18, the valve 20 is closed and the described suspension is blocked. In the described configuration, the vehicle in operation is designed to be stiffer than the control of the plow so that the pertinent field work is not adversely affected. Although the pilot-actuated valve 20 has a small structure and does not require additional energy, the high flow rates necessary for suspension between the suspension cylinders 10 and the suspension accumulators 18 can be easily achieved through the valve 20.

Alternatively to the aforementioned hydropneumatic suspension, provision can be made such that the choke 30 with the return valve 34 in the line 48 are completely omitted. Instead, a flow control valve 31 can be connected between the input 40 of the switching valve 24 and the tank 44, upstream of the branch 33 of the connecting line 52 connected to the reset side 54 of the valve 20. This alternative embodiment is shown in FIG. 1 in a box outlined by a broken line.

While various embodiments have been chosen to illustrate the invention, it will be understood by those skilled in the art that various changes and modifications can be made therein without departing from the scope of the invention as defined in the appended claims.

What is claimed is:

1. A hydropneumatic suspension, comprising:
at least one suspension cylinder;
at least one suspension accumulator; and
a controllable valve connecting said cylinder and said accumulator and being movable between an open position providing fluid communication therethrough and a closed position blocking fluid communication therethrough, said controllable valve being movable to the closed position by a hydraulically operated control.

2. A hydropneumatic suspension according to claim 1 wherein said accumulator is a hydraulic accumulator.

3. A hydropneumatic suspension according to claim 1 wherein said controllable valve is a proportion valve.

4. A hydropneumatic suspension according to claim 3 wherein said proportional valve is a pilot-actuated valve.

5. A hydropneumatic suspension according to claim 4 wherein
said hydraulically operated control taps fluid pressure from said accumulator and said cylinder, and relays that fluid pressure to a switching valve to an actuation side of said pilot-actuated valve.

6. A hydropneumatic suspension according to claim 5 wherein
a tapping point located between said pilot-actuated valve and said accumulator is in fluid communication with said hydraulically operated control.

7. A hydropneumatic suspension according to claim 5 wherein
a choke is connected between said switching valve and an actuation side of said pilot-actuated valve; and
a non-return valve is located in a secondary branch connected in parallel to said choke, said non-return valve opening against a spring bias in a direction of said actuation side of said pilot-actuated valve.

8. A hydropneumatic suspension according to claim 5 wherein
a flow control valve is connected between an input of said switching valve and a tank and connected upstream of a branch of a connecting line in fluid communication with a reset side of said pilot-actuated valve.

9. A hydropneumatic suspension according to claim 4 wherein
a choke is in a secondary line, connected in parallel to said pilot-actuated valve, between said accumulator and said cylinder.

10. A hydropneumatic suspension according to claim 4 wherein
a reset spring on a reset side of said pilot-actuated valve biases said pilot-actuated valve toward said open position thereof, forming a neutral position thereof; and
a connecting line provides fluid communication between said reset side and a tank connection.

11. A hydropneumatic suspension according to claim 5 wherein
said pilot-actuated valve is a 2/2-way valve; and
said switching valve is a 3/2-way seat valve.

12. A hydropneumatic suspension according to claim 11 wherein
said switching valve is hand actuated, and in an unactuated, neutral position provides fluid communication through a connecting line between a tank connection and said actuating side of said pilot-actuated valve.

13. A hydropneumatic suspension according to claim 5 wherein
said switching valve is hand actuated, and in an unactuated, neutral position provides fluid communication through a connecting line between a tank connection and said actuating side of said pilot-actuated valve.

14. A hydropneumatic suspension according to claim 4 wherein
said pilot actuated valve has a pilot part with a pilot piston formed as a slide with parts of said pilot-actuated valve and sealed to actuation and reset sides of said pilot-actuated valve.
